(19) United States
(12) Patent Application Publication
(10) Pub. No.: US 2008/0159066 A1
(43) Pub. Date: Jul. 3, 2008

(54) Shock absorbing buffer structure for an amalgam mixer

(76) Inventor: Shu-Lung Wang, Taipei Hsien (TW)

Correspondence Address: Joe McKinney Muncy, PO Box 1364, Fairfax, VA, 22038-1364, US

(21) Appl. No.: 11/646,296

(22) Filed: Dec. 28, 2006

(51) Int. Cl. B01F 11/00; F16F 15/04

(52) U.S. Cl. 366/217

(57) ABSTRACT

A shock absorbing buffer structure for an amalgam mixer includes a driving power mechanism to generate a driving force to evenly mix materials held in a container and a plurality of buffer units to support the driving power mechanism. The structure can absorb vibration generated by the driving power mechanism during operation to reduce shock and noise.

### FIELD OF THE INVENTION

The present invention relates to a shock absorbing buffer structure for an amalgam mixer and particularly to an amalgam mixer that has a buffer and shock absorbing structure to absorb vibration during operation.

### BACKGROUND OF THE INVENTION

Silver amalgam filler has been used in dentistry for more than one hundred and fifty years. The rudimentary method for making the silver amalgam is as follow: holding mercury and silver powder in a measuring container, placing the container upside down to squeeze and discharge a selected amount of mercury and silver powder into a silver amalgam grinding device, and pressurizing, grinding and mixing evenly the mercury and silver powder. As the silver amalgam is a plastic alloy at room temperature, it can be filled into a tooth cavity and cured after a period of time. The characteristics of the silver amalgam vary according to different compositions of the mercury and silver powder and grinding time. The contemporary operation method is placing mercury and silver powder of a selected ratio into a capsule separating by a thin layer. When in use place the capsule in an amalgam mixer and set a selected time to process the mixing operation. The conventional amalgam mixer generates a great mechanical vibration and noise during mixing the solver powder and mercury at high speed shaking. The great vibration easily causes mechanical fatigue of mechanical elements and makes life span shorter and operation efficiency lower. The noise also is an annoyance to people and seriously interferes the working spirit of the dentist. All these shortcomings are pending to be overcome.

### SUMMARY OF THE INVENTION

In view of the problems of the conventional amalgam mixers of generating too much vibration and noise, the primary object of the present invention is to provide an amalgam mixer to reduce vibration and noise.

The present invention provides a shock absorbing buffer structure for an amalgam mixer that includes a driving power source, a transmission portion, a forcing arm, a bottom tray and a supporting chassis to hold the driving power source, transmission portion and forcing arm. The supporting chassis has a plurality of buffer units on the periphery. Each of the buffer units includes a first buffer element, a second buffer element, a plurality of washers, a detention strut, an adjustment element and a transverse supporting plate connecting to the supporting chassis. The first and second buffer elements are compressible and can generate returning elasticity after compressed. The transverse supporting plate is located between the first and second buffer units to hold the supporting chassis above the bottom tray in a suspension manner. During operation the first and second buffer elements generate a buffer space above and below the supporting chassis. The first and second buffer elements also generate a damping to reduce vibration of the supporting chassis during operation. The amalgam mixer thus constructed can be maintained steadily without generating a lot of noise.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fragmentary exploded view of an embodiment of the invention.

FIG. 2 is a perspective view of an embodiment of the invention.

FIG. 3A is a fragmentary enlarged schematic view of an embodiment of the invention.

FIG. 3B is another fragmentary enlarged schematic view of an embodiment of the invention.

### DETAILED DESCRIPTION OF THE PREFERRED EMBODIMENT

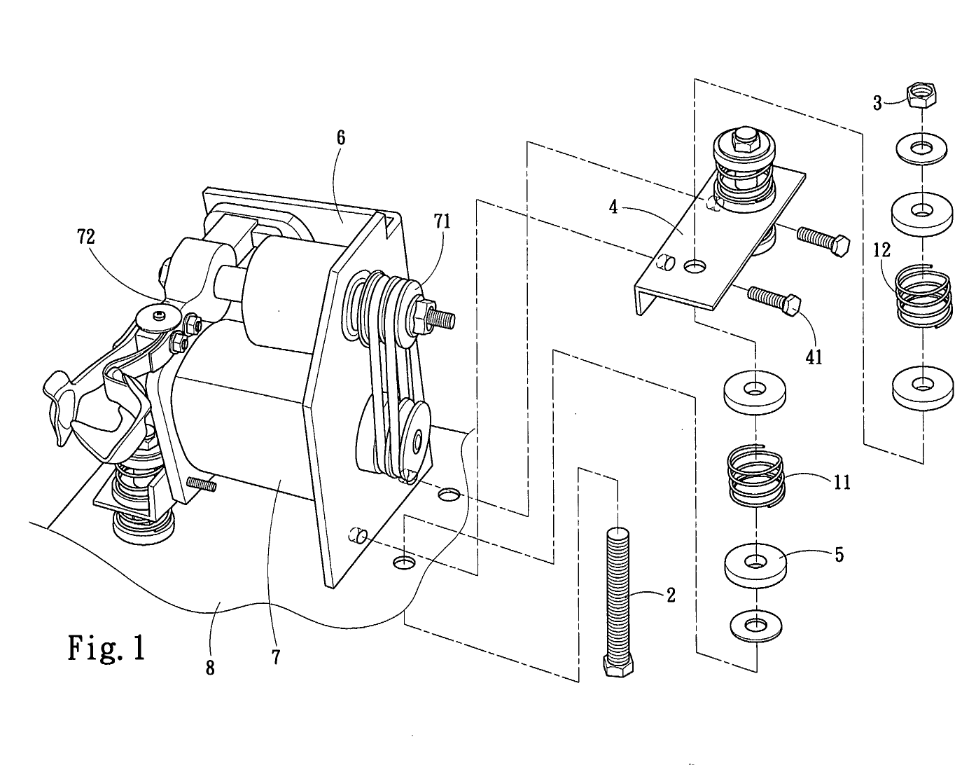

Please refer to FIG. 1 for a fragmentary exploded view of an embodiment of the amalgam mixer of the invention. It includes a driving power source 7, a transmission portion 71 to transmit the driving power of the driving power source 7, a forcing arm 72 connecting to the transmission portion 71 to get the driving power and a bottom tray 8 to hold all the elements. The forcing arm 72 has a front end to hold a container which contains mercury and silver powder. The forcing arm 72 can be driven by the transmission portion 71 to shake the container at high speed to evenly mix the mercury and silver powder to become a stable silver mercury alloy. The driving power source 7, transmission portion 71 and forcing arm 72 are installed on a supporting chassis 6. The supporting chassis 6 has a plurality of buffer units 1 on the periphery. Each of the buffer units 1 includes a first buffer element 11 and a second buffer element 12 that are compressible and can generate returning elasticity when compressed, a plurality of washers 5 located on upper and lower two ends of the first and second buffer elements 11 and 12, a detention strut 2 and an adjustment element 3 located on an upper end of the detention strut 2. The adjustment element 3 may be a nut. The buffer unit 1 is coupled with the supporting chassis 6 through a transverse supporting plate 4 which is fastened to one side of the supporting chassis 6 through a plurality of screws 41. The first buffer element 11 is located between the transverse supporting plate 4 and the bottom tray 8. The second buffer element 12 is located on the transverse supporting plate 4. The washers 5 are located on two ends of the first and second buffer elements 11 and 12. The transverse supporting plate 4 has a round hole to allow the detention strut 2 to pass through. The detention strut 2 runs through the first and second buffer elements 11 and 12, washers 5 and the transverse supporting plate 4. The detention strut 2 has a lower end fastened to the bottom tray 8 and an upper end coupled with the adjustment element 3. The adjustment element 3 has screw threads to engage with the detention strut 2 and is movable up and down on the detention strut 2, thereby to press the washer 5 located on the upper side of the second buffer element 12 to compress the space of the first and second buffer elements 11 and 12. Hence the first and second buffer elements 11 and 12 are located on upper and lower two ends of the transverse supporting plate 4 and remain at desired positions to suspend the supporting chassis 6 above the bottom tray 8.

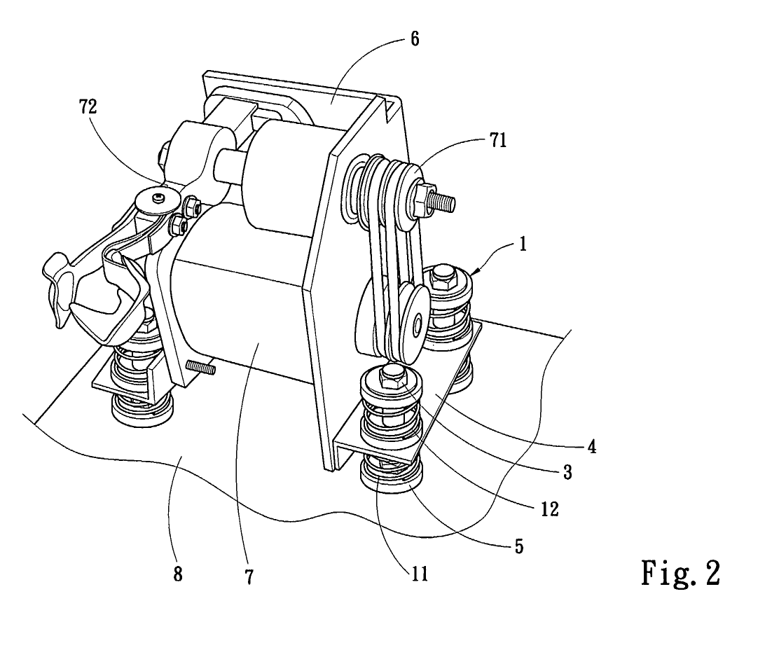

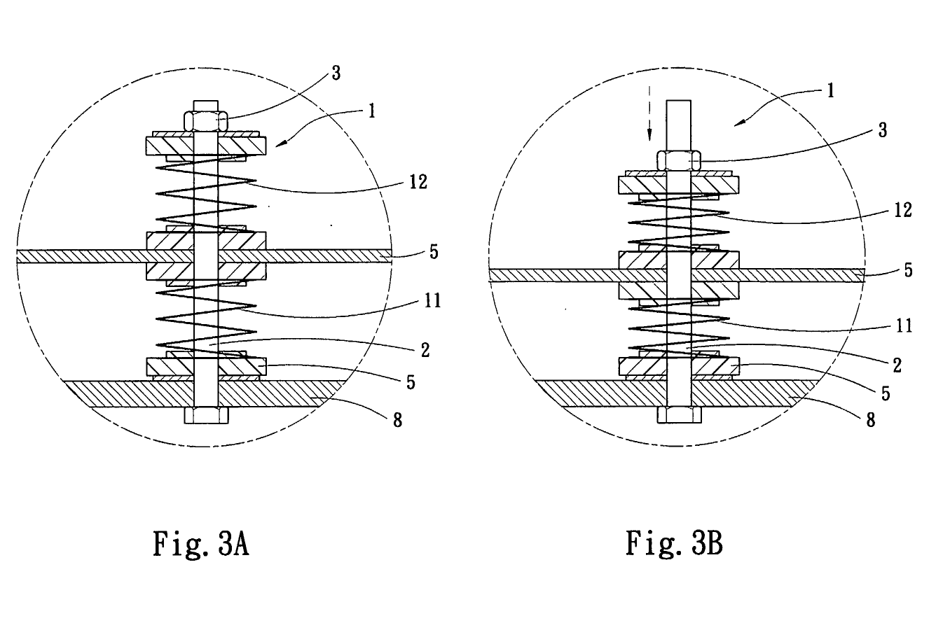

Referring to FIGS. 2, 3A and 3B, the driving power source 7, transmission portion 71, forcing arm 72 and supporting chassis 6 are suspended above the bottom tray 8 through the buffer units 1 installed on the transverse supporting plate 4. The first and second buffer elements 11 and 12 have the upper and lower ends pressing the transverse supporting plate 4 so that vibration generated by the transmission portion 71 and forcing arm 72 during operation is absorbed by the first and second buffer elements 11 and 12 on the transverse supporting plate 4. Thereby shock absorbing and noise reducing effect can be achieved. The damping of the buffer unit 1 can be adjusted to reduce the vibration. This is accomplished through the adjustment element 3 on each buffer unit 1 by rotation to move up or down on the detention strut 2. When the adjustment element 3 is moved downwards (referring to FIG. 3B), the first and second buffer elements 11 and 12 are compressed, their elastic forces are applied to the transverse supporting plate 4 in the middle, thus a greater damping against vibration is formed on the transverse supporting plate 4. To do otherwise, a smaller damping is formed. Hence the buffer unit 1 can be adjusted as required to alter the damping to achieve optimal shock absorbing and noise reducing effect.

The embodiment set forth above serves merely illustrative purpose and is not the limitation of the invention. For instance, the first and second buffer elements 11 and 12 may be springs or elastic bending reeds that are compressible and have returning elasticity after compressed. The transverse supporting plate 4 may be integrally formed and interposed between the buffer units 1, or include a plurality of separated transverse plates each being interposed between the buffer units 1.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A shock absorbing buffer structure for an amalgam mixer which includes a driving power source, a transmission portion, a forcing arm, a bottom tray and a supporting chassis to hold the driving power source, the transmission portion and the forcing arm, comprising a plurality of buffer units each having:
a transverse supporting plate fastened to the supporting chassis and extended outwards;
a first buffer element located between the transverse supporting plate and the bottom tray;
a second buffer element located above the transverse supporting plate;
a plurality of washers located on an upper end and a lower end of the first buffer element and the second buffer element;
a detention strut which is fastened to the bottom tray and runs through the first buffer element, the transverse supporting plate, the second buffer element and the washers; and
an adjustment element which is located on-an upper end of the detention strut and movable up and down to a desired location on the detention strut to press the washer on the upper side of the second buffer element to compress the first buffer element and the second buffer element such that the first and second buffer elements generate desired damping in response to vibration of the transverse supporting plate to absorb vibration of the supporting chassis.

2. The shock absorbing buffer structure for the amalgam mixer of claim 1, wherein the first buffer element and the second buffer element are springs.

3. The shock absorbing buffer structure for the amalgam mixer of claim 1, wherein the transverse supporting plate is integrally formed and located between the first buffer element and the second buffer element.

4. The shock absorbing buffer structure for the amalgam mixer of claim 1, wherein the transverse supporting plate includes at least one separated transverse plate located between the first buffer element and the second buffer element.

5. The shock absorbing buffer structure for the amalgam mixer of claim 1, wherein the detention strut has screw threads formed thereon.

6. The shock absorbing buffer structure for the amalgam mixer of claim 5, wherein the adjustment element is a nut.

7. The shock absorbing buffer structure for the amalgam mixer of claim 1, wherein the first buffer element and the second buffer element are bending steel blades that have returning elasticity after compressed.
